(19) United States
(12) Patent Application Publication
(10) Pub. No.: US 2005/0282566 A1
(43) Pub. Date: Dec. 22, 2005

(54) Apparatus and method for constructing and routing a message

(76) Inventors: Craig S. Bixler, Saint Charles, IL (US); David W. Brown, Aurora, IL (US); Ping Li, Naperville, IL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/136,551

(22) Filed: May 25, 2005

Related U.S. Application Data
(60) Provisional application No. 60/575,818, filed on Jun. 2, 2004.

(51) Int. Cl. H04Q 7/20

(52) U.S. Cl. 455/466

(57) ABSTRACT

An apparatus and method for responding to an input signal by accessing a data source, retrieving relevant data and utilizing the data to construct and route an outgoing message. Using this apparatus and method, hospitals can provide efficient and personalized responses to patient requests, which can be initialized via a nurse call device. These efficient and personalized responses are accomplished by accessing a data source to obtain specific information about a patent, and then routing relevant portions of the information, via a text message, to those having privy to the information and responsible for caring for the patient.

### CROSS-REFERENCE TO RELATED APPLICATIONS

This application claims priority to U.S. patent application entitled, AUTOMATIC AND MANUAL HOSPITAL STAFF MESSAGING WITH PATIENT INFORMATION, filed Jun. 2, 2004, having a Ser. No. 60/575,818, the disclosure of which is hereby incorporated by reference in its entirety.

### FIELD OF THE INVENTION

The present invention relates generally to the field of communication networks. More particularly, the present invention relates to an apparatus and method for responding to an input signal by accessing a data source, retrieving relevant data and utilizing the data to construct and route an outgoing message.

### BACKGROUND OF THE INVENTION

Many hospitals today utilize text messaging to facilitate communication between hospital staff and patients. Often times, these hospital communication devices combine text messaging and wireless phone communication. Thus, after receiving a text message that indicates a patient request, a staff member can establish two-way voice communication with the patient.

However, these current hospital communication devices are deficient because the text message contains only limited information about the patient. For example, the content of the text message is limited to basic and nonspecific information such as bed location, call urgency, and time of notification information.

Text messages that contain specific information about the patient, such as the patient's name, identification number, diagnosis, allergies, language spoken, can enable staff to provide more efficient and personalized care. For example, when establishing voice communication with the patient, it is desirable to address the patient by name and, thus, foster a more personal conversation with the patient. Further, if the patient is a non-English speaking patient, it is desirable to address the patient using the appropriate language. Also, a text message that contains specific information about the patient, such as dietary or medication information, can enable staff to address the patient's request without having to actually visit or establish voice communication with the patient. Thus, staff can provide more efficient service.

Accordingly, it is desirable to provide an apparatus and method for retrieving, pursuant to an input signal, applicable data from a data source and utilizing the retrieved data to construct and route an outgoing message. Hospitals can provide efficient and personalized responses to patient requests by using this apparatus and method to access a data source and obtain specific information about the patient that is requesting assistance, and then route the relevant portions of the information, via a text message, to those having privy to the information and responsible for caring for the patient.

### SUMMARY OF THE INVENTION

The foregoing needs are met, to a great extent, by the present invention, wherein in one aspect an apparatus is provided that in some embodiments responds to an input signal by accessing a data source and retrieving relevant data and utilizing the data to construct and route an outgoing message.

In accordance with one embodiment of the present invention is an apparatus for communicating, comprising a computer processing device linked to a network and configured to receive data from the network, analyze the data and provide a text message to the network; a router linked to the computer processing device configured to route an input and the text message; a database linked to the router configured to receive, store and provide substantive data and routing data, and a message generator linked to the database configured to generate the text message based on the substantive data and determine a routing destination for the text message based on the routing data.

In accordance with another embodiment of the present invention is a method for communicating, comprising the steps of receiving an input; retrieving data from a database based on the input; analyzing the data and the input; generating a text message based on an analysis of the data and the input, and routing the text message to a peripheral.

In accordance with yet another embodiment of the present invention is an apparatus for automatically constructing and routing a message, comprising: a computer processing device linked to a network and configured to receive data from the network, analyze the data and provide a text message to the network; a router linked to the computer processing device configured to route an input and the text message; a database linked to the router configured to receive, store and provide substantive data and routing data; and a real time transaction server linked to the database and configured to transmit the input to an automatic message generator. Wherein, upon receiving the input, the automatic message generator is configured to utilize the input to locate the substantive data and the routing data, prescribe a content for the text message based on the substantive data, and prescribe a routing destination for the text message based on the routing data.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram illustrating a communication network according to the preferred embodiment of the present invention.

FIG. 2 is a block diagram of an apparatus capable of constructing and routing a message according to the preferred embodiment of the present invention.

FIG. 3 is a flowchart outlining an operation for a system capable of automatically constructing and routing a message according to the preferred embodiment of the present invention.

FIG. 4 is a flowchart outlining an operation for a system capable of automatically constructing and routing a message according to an alternative embodiment of the present invention.

FIG. 5 is a flowchart outlining an operation for a system capable of constructing and routing a message pursuant to the manual control of an operator according to the preferred embodiment of the present invention.

FIG. 6 is a flowchart outlining an operation for a system capable of constructing and routing a message pursuant to the manual control of an operator according to an alternative embodiment of the present invention.

### DETAILED DESCRIPTION

The invention will now be described with reference to the drawing figures, in which like reference numerals refer to like parts throughout. The present invention provides an apparatus and method for responding to an input signal by accessing a data source, retrieving relevant data and utilizing the data to construct and route an outgoing message. An embodiment in accordance with the present invention provides an input device, a data source, a managing device, an output device, and a network linking the aforementioned devices. The managing device is in continuous communication with the data source and the input device, such that the data source and the input device update the managing device when data is newly added or modified or when conditions related to the input device change. In operation, an input signal is sent from the input device to the managing device. Based on the input signal and the continuously updated information obtained from the data source and the input device, the managing device constructs and routes a message to the output device.

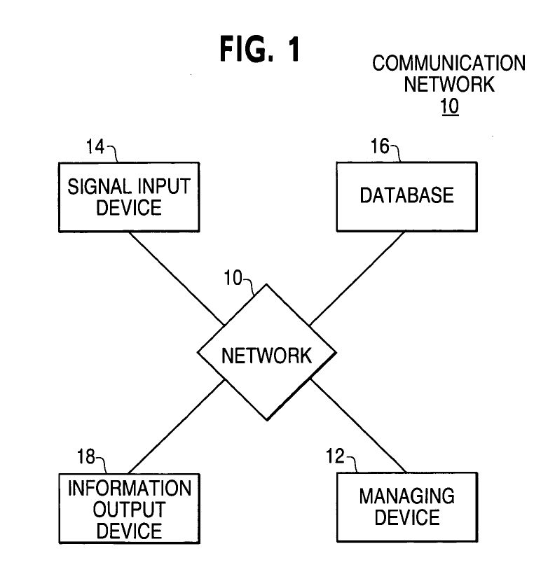

FIG. 1 is an exemplary communication network 10 according to the disclosed apparatus and method. As shown in FIG. 1, the exemplary network 10 includes a managing device 12, a signal input device 14, a database 16, and an information output device 18. It should be appreciated that the above mentioned components 12-18 can be linked together by any architecture that is well known to those of ordinary skill in the art.

The communication network 10 can, for example, provide communication between hospital staff and patients. For example, a patient can signal the managing device 12 via the signal input device 14. Based on the particular signal indicated and the continuously up-to-date information obtained from the database 16 and the signal input device 14, the managing device 12 can construct a patient-specific outgoing message and send the message to appropriate hospital staff via an information output device 18.

The signal input device 14 can be, for example, a nurse call device, where the patient can choose between standard indicator buttons, such as a bathroom button, an emergency button, a staff assistant button, or a nurse call button. Also, the signal input device 14 can be an automated machine, for example, a heart monitor that can signal the managing device 12 when a irregular heartbeat occurs.

The signal input device 14 is in continuous communication with the managing device 12, such that the signal input device 14 provides updated data regarding its location, i.e., intensive care unit or pediatrics. Also, the signal input device 14 can update the managing device 12 regarding the status or condition of the patient.

The database 16 can be, for example, an admit discharge transfer system (hereinafter referred to as “ADT”). The ADT maintains a census for the hospital, for example, the name and status of each admitted patient. The ADT is in continuous communication with the managing device 12 via an industry standard HL7 protocol. For example, when a patient is admitted to the hospital, the ADT will communicate the newly admitted patient's information to the managing device 12. The managing device 12 can locally store the new patient's information, and utilize the information when constructing a patient-specific outgoing message.

The ADT can provide to the managing device 12 information such as the patient's name, identification number, diagnosis, allergies, emergency contact information, and what language the patient speaks.

The information output device 18 can take many different forms and be utilized in many different locations. For example, the output device 18 can be a pager, cell phone, intercom system display, or a display monitor. It should be appreciated that the output device 18 can be any device capable of receiving a text message.

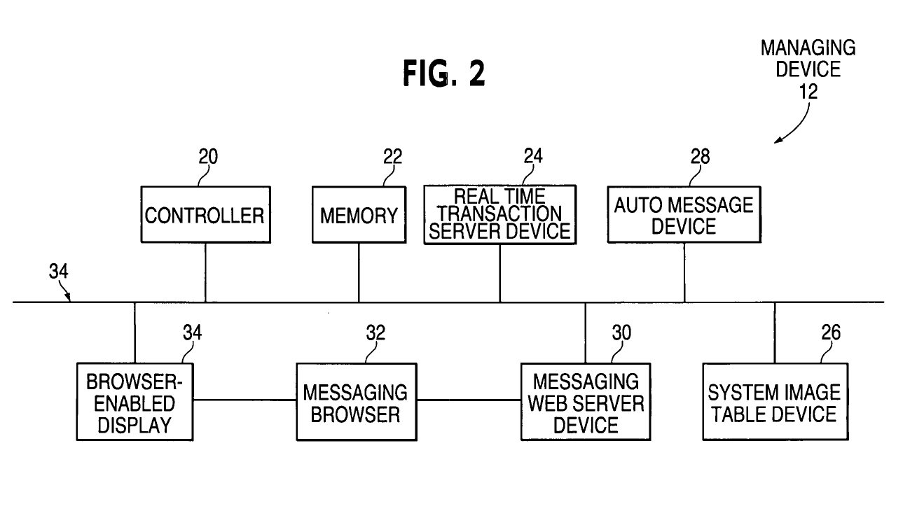

Referring now to FIG. 2, the managing device 12 can include, for example, a controller 20, a memory 22, a real time transaction server 24, a system image table device 26, an automatic message generating device 28, a message web server 30, a manual message generating device 32, and a browser-enabled display 34. The above mentioned components can be coupled by a control/data bus 34. Although, it should be appreciated that any other architecture, as known to those of ordinary skill in the art, may be used to couple the above mention components. It should also be appreciated that components 24-32 can take the form of software/firmware routines residing in memory 22 capable of being executed by the controller 20.

The real time transaction server 24 receives input signals from the signal input device and routes the input signals to the automatic message device 28. Also, the real time transaction server 24 receives outgoing messages from both the automatic message device 28 and the manual message web server device 30. Upon receiving the outgoing messages, the real time transaction server 24 routes the outgoing messages to the information output devices 18.

In an alternative embodiment, the real time transaction server 24 receives incoming signals from the signal input device 14, identifies the specific type of signal received, and routes the incoming signal accordingly. For example, the real time transaction server 24 can receive an incoming signal and identify whether it is a bathroom assistance call, an emergency call, a code blue call, or nurse assistance call. Based on the specific type and time of receipt, the real time transaction server 24 routes the incoming signal to either the automatic message device 28 or a browser-capable display 34.

Also, in the alternative embodiment, the real time transaction server 24 is programmable such that it routes incoming signals pursuant to programming instructions. A system administrator can program the real time transaction server 24 to route incoming signals to either the automatic message device 28 or the browser-capable display 34 based on, for example, the specific circumstances present in the particular location where which the signal input device is located. For example, if the signal input device is located in an intensive care unit, the real time transaction server can route the incoming signal to the automatic message device because it can construct and route an outgoing message without the need for manual intervention. It should be appreciated that factors other than, or in addition to, time and type of the incoming signal can be used to determine whether the incoming signal is routed to the automatic message device 28 or to a particular browser-capable display 34, or to both.

The system image table device 26 stores and organizes the information obtained by the managing device 12 pursuant to its continuous communication with the signal input device 14 and the database 16. Thus, when utilized in a hospital, the system image table device 26 contains up-to-date information relating to each admitted patient. For example, the system image table device 26 contains information that indicates the particular information fields that are to be included in the outgoing message, substantive information that corresponds with the required information fields, and routing information that determines where the outgoing message is to be routed in order to properly respond to the incoming signal.

When utilized in a hospital, the system image table device 26 provides, for example, the automatic message device 28 with particular information fields based on the room number within the input signal. These informations may include a room name, the name of the signaling patient, and the diagnosis of the signaling patient. The system image table device 26 also provides the corresponding substantive data for the aforementioned information fields. Further, the system image table device 26 provides routing information, such as to which doctor, nurse, staff member, or team the outgoing message should be routed and the routing information for the output device 18 associated with the message receiving doctor, nurse, staff member or team.

The automatic message device 28 is capable of automatically constructing an outgoing message and assigning an appropriate routing instructions based on the incoming signal type and the information it receives from the system image table device 26. For example, when the real time transaction server 24 routes an incoming signal to the automatic message device 28, the automatic message device 28 accesses the system image table device 26, where it obtains information relevant to the incoming signal. For example, the automatic message device 28 accesses the system image table device 26 to obtain, among other things, the applicable format for the outgoing message. In other words, the automatic message device 28 obtains, from the system image table device 26, the specific information fields that correspond with the specific type of incoming signal. The automatic message device 28 also obtains, from the system image table device 26, the substantive data that corresponds with each of the applicable information fields. The automatic message device 28 then constructs an outgoing message comprising the substantive data that corresponds with each of the applicable information fields and assigns routing instructions that properly respond to the incoming signal. It should be noted that the automatic messaging device may route the message to multiple output devices 18, and may add various delays before each routing to create a routing sequence that gives each output device 18 some amount of time to respond to the message before the next output device is signaled.

The message browser device 32 is capable of submitting an input signal to the message web server 30, and the message web server 30 is capable of obtaining all information related to the input signal from the system image table device 26. For example, when the message web browser 32 submits an incoming signal to the message web server 30, the message web server 30 accesses the system image table device 26, where it obtains all information relating to the origin of the incoming signal, which may include login and/or bed number. The origin of the incoming signal can be, for example, the nursing unit in which a particular patient is located. The information provided to the message browser device 32, for example, includes a list of all beds in the nursing unit, the patient name associated with each bed, the particular staff member associated with each patient, and the routing information for output device 18 associated with each staff member. The message web server 30 then sends all of the information obtained from the system image table device 26 to the message browser device 32.

In an alternative embodiment, the message web server 30 is capable of identifying the incoming signal based on a login, and obtaining all related information from the system image table device 26. For example, when the real time transaction server 24 routes an incoming signal to a browser-enabled display 34, the display operator can launch a browser 32, which signals the message web server 30 with auto-login and/or bed number information. The message web server 30 accesses the system image table device 26 where it obtains all information relating to the origin of the incoming signal. The origin of the incoming signal can be, for example, the patient responsible for submitting the incoming signal. This is in contrast to the automatic message device 28, which accesses specific information relating to the incoming signal. The message web server 30 then routes all of the information obtained from the system image table device 26 to the message browser device 32.

The message browser device 32 presents all of the information received from the message web server device 30 to an operator. The operator can select among the presented information and, thereby, manually construct an outgoing message and assign routing information thereto.

The browser-enabled device 34 is a display output and a browser input. The browser-enabled device 34 continuously receives information from various devices in the network 10, such as the database 16 and signal input device 14. It should be appreciated that the browser-enabled device 34 can receive information from sources not linked to the network 10. The browser-enabled device 34 displays the continuous information to an operator. Further, the browser-enabled device 34 enables the operator to generate a message and route the message to the messaging web server device 30.

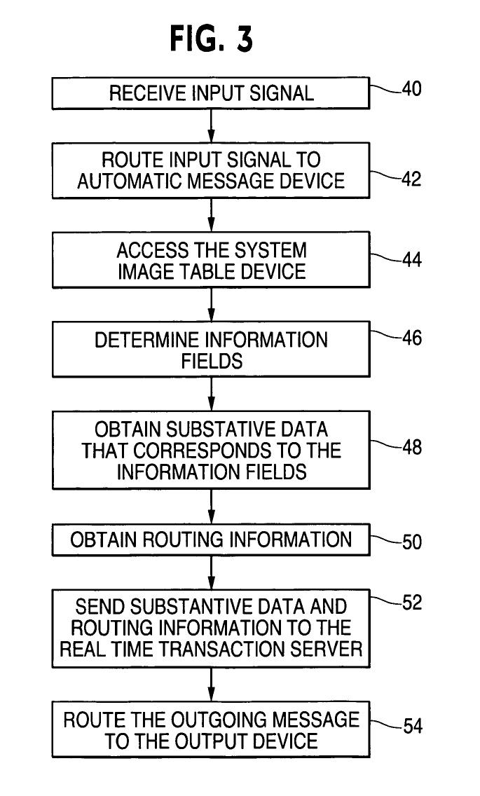

FIG. 3 is a flowchart outlining an exemplary operation according to the present disclosure for a system capable of automatically constructing and routing a message. The operation starts at step 40, where the real time transaction server 24 receives an input signal. Next, in step 42, the real time transaction server 24 routes the input signal to the automatic message device 28. Once the automatic message device 28 receives the incoming signal, the system proceeds to step 44, where the automatic message device 28 accesses the system image table device 26.

Once the automatic message device 28 accesses the system image table device 26, the system next performs step 46, which is to determine the information fields necessary to adequately construct an outgoing message. Once the information fields are determined, the system proceeds to step 48 where the automatic message device 28 obtains from the system image table device 26 the substantive data that corresponds to the information fields determined in step 48. Next, in step 50, the automatic message device 28 obtains, from the system image table device 26, the routing information for the outgoing message. In step 52, the automatic message device 28 routes the prescribed message and routing information to the real time transaction server 24, and in step 54 the real time transaction server 24 routes the outgoing message to the specified output devices 18.

The operation outlined in FIG. 3 can be understood by the following example. A patient, in need of nurse assistance, presses the nurse call button, which is located on the signal input device 14. The signal input device 14 then transmits an input signal to the automatic message device 28 via the real time transaction server 24. The automatic message device 28 recognizes the input signal as a nurse call signal. The automatic message device 28 then accesses the system image table device 26, where it obtains the name of the requesting patient, the nurse responsible for the requesting patient, and the routing information for the information output device 18 associated with that particular nurse. The automatic message device 28 then sends the routing information along with a message containing the name of the patient and that the patient requests nurse assistance to the real time transaction server 24. The real time transaction server 24 then transmits the outgoing message to the corresponding output device 18.

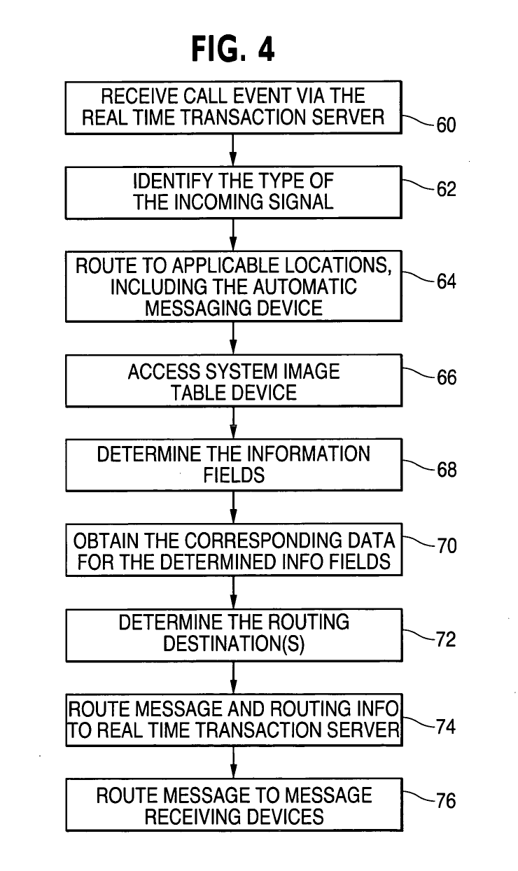

FIG. 4 is a flowchart outlining an operation for a system capable of automatically constructing and routing a message according to an alternative embodiment of the present invention. The operation starts at step 60, where the real time transaction server 24 receives an incoming signal. Next, in step 62, the real time transaction server 24 identifies the specific type of the incoming call. For example, the incoming signal can be a staff call, an emergency call, a bed call, or a bathroom call.

Once the specific type of the call has been identified, the real time transaction server 24 routes the incoming signal to all devices configured to receive that specific type of incoming signal, as shown in step 64. If the incoming signal is of the type that requires automatic construction and routing of an outgoing message, the real time transaction server 24 routes the incoming signal to at least the automatic message device 28. Once the automatic message device 28 receives the incoming signal, the system proceeds to step 66, where the automatic message device 28 accesses the system image table device 26.

Once the automatic message device 28 accesses the system image table device 26, the system next performs step 68, which is to determine the information fields necessary to adequately construct an outgoing message. Once the information fields are determined, the system proceeds to step 70 where the automatic message device 28 obtains from the system image table device 26 the substantive data that corresponds to the information fields determined in step 46. Next, in step 72, the automatic message device 28 obtains, from the system image table device 26, the routing instructions for the outgoing message. In step 74, the automatic message device 28 routes the prescribed message and routing instructions to the real time transaction server 24, and in step 76, the real time transaction server 24 routes the outgoing message to the specified information output devices 18.

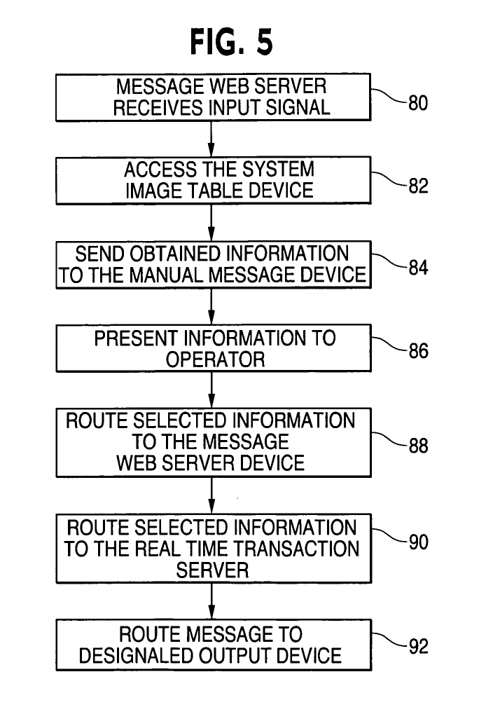

FIG. 5. is a flowchart outlining an operation for a system capable of constructing and routing a message according to manual instruction from an operator according to the preferred embodiment of the present invention. First, in step 80, the messaging browser 32 sends an input signal to the message web server device 30. Next, in step 82, the message web server device 30 accesses the system image table device 26 to obtain all information relevant to the input signal. Next, in step 84, the message web server device 30 sends all of the obtained information back to the manual message device 32.

Next, in step 86, the manual message device 32 presents all of the obtained information to an operator. Based on the information presented, the operator can manually construct a message and designate routing instructions for the message. Once the operator has constructed the message and selected routing appropriate routing information, the manual message device 32 routes an outgoing message and the associated routing information to the message web server device 30, as shown in step 88. Next, in step 90, the message web server device 30 routes the outgoing message and associated routing information to the real time transaction server 24. Finally, in step 92, the real time transaction server 24 routes the message to the designated output device 18.

The operation outlined in FIG. 5 can be understood by the following example. The input signal is a telephone call from the laboratory to an operator in charge of a particular nursing unit. The telephone message indicates that lab results for a particular patient are complete. The operator then accesses the messaging browser 32. Upon access, the messaging browser 32 accesses the system image table device 26 via the message web server device 30. From this access, the message browser 32 displays, to the operator, information relevant to that particular nursing unit. For example, the message browser 32 presents to the operator a list of all beds in the nurse unit, the patient name associated with each bed, the particular staff member associated with each patient, and the routing information for the output device 18 associated with each staff member.

The operator indicates the patient for which the laboratory results are associated and constructs a message indicating that the laboratory results are complete. The message browser 32 then sends the message and the routing information for the output information output device 18 associated with the particular staff member responsible for the patient to the message web server device 30. The message web server device then sends the message and routing information to the real time transaction server 24. The real time transaction server then sends the message out to the information output device 18.

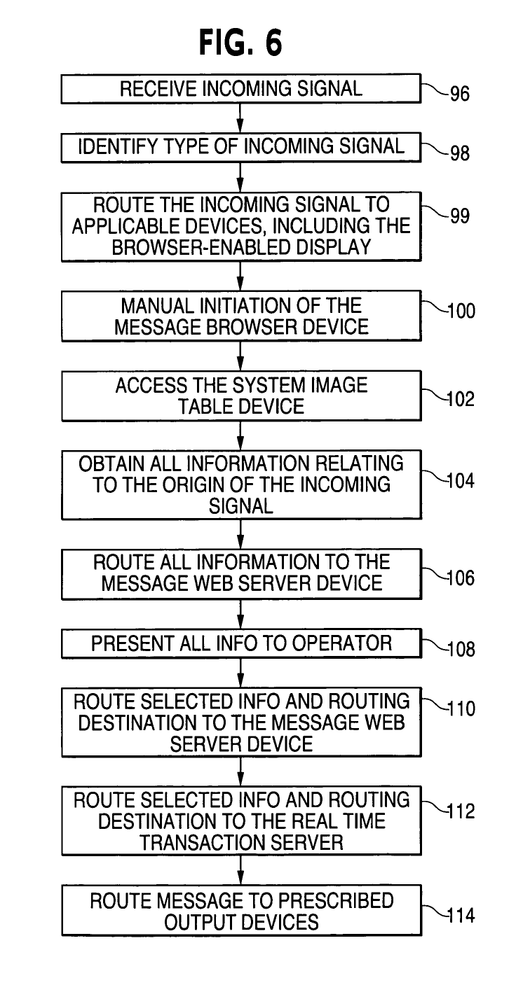

FIG. 6. is a flowchart outlining an operation for a system capable of constructing and routing a message pursuant to manual instruction from an operator according to an alternative embodiment of the present invention. The operation starts at step 96 where the real time transaction server 24 receives an incoming signal. Next, in step 98, the real time transaction server 24 identifies the specific type of the incoming call. For example, the incoming signal can be a staff call, an emergency call, a bed call, or a bathroom call.

Once the specific type of the call has been identified, the real time transaction server 24 routes the incoming signal to all devices configured to receive that specific type of incoming signal, as shown in step 99. If the incoming signal is of the type that requires that an outgoing message be manually constructed, the real time transaction server 24 routes the incoming signal to at least a browser-enabled display 34. An operator reads the display and determines that a message is required and initiates the browser 32 with an automatic login, bed, or nursing unit, as shown in step 100. The message browser 32 routes the incoming signal along with the automatic login, bed, or nursing unit to the message web server device 30. Once the message web server device 30 receives the incoming signal, the system proceeds to step 102, where the message web server device 30 accesses the system image table device 26.

Upon accessing the system image table device 26, the system next performs step 104, where the message web server device 30 obtains, from the system image table device 26, all information relating to the origin of the incoming signal. Next, in step 106, the message web server device 30 routes all of the obtained information to message browser device 32.

Next, in step 108, the message browser presents all of the information relating to the origin of the incoming signal to an operator. Based on the information presented, the operator can manually construct a message and assign a routing instructions for the message. Once the operator has constructed the message and selected routing instructions, the message browser 32 routes the outgoing message and prescribed instructions to the message web server device 30, as shown in step 110. Next, in step 112, the message web server device 30 routes the outgoing message and prescribed instructions to the real time transaction server 24. Finally, in step 114, the real time transaction server routes the message and to the prescribed destination, also referred to as the information output device 18.

Although the present apparatus and method is useful to construct and route hospital patient message requests, it can also be used construct and route message requests in other settings.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. An apparatus for communicating, comprising:
a computer processing device linked to a network and configured to receive data from the network, analyze the data and provide a text message to the network;
a router linked to the computer processing device configured to route an input and the text message;
a database linked to the router configured to receive, store and provide substantive data and routing data, and
a message generator linked to the database configured to generate the text message based on the substantive data and determine a routing destination for the text message based on the routing data.

2. The apparatus of claim 1, wherein the database is populated by an admit discharge transfer system.

3. The apparatus of claim 2, wherein the database communicates with the admit discharge transfer system via a HL7 protocol.

4. The apparatus of claim 1, wherein the substantive data is a name, an age, a diagnosis, a language spoken, an allergy, an assigned doctor, an assigned nurse, an assigned staff member, an emergency contact, a diet, a list of medicines, and a prognosis.

5. The apparatus of claim 1, wherein the routing data is a routing instruction for routing the text message to a text message device.

6. The apparatus of claim 1, wherein the input is a hospital bed number.

7. The apparatus of claim 6, wherein the input is selected from the group consisting of a bathroom signal, a bed lift signal, a nurse call signal, an emergency signal, a cold blue signal, a cardiac signal, and a low fluid signal.

8. The apparatus of claim 1, wherein the router is a real time transaction server and the message generator is an automatic message generator.

9. The apparatus of claim 8, wherein the real time transaction server transmits the input to the automatic message generator, and the automatic message generator utilizes the input to locate the substantive data and the routing data in the database.

10. The apparatus of claim 9, wherein the automatic message generator automatically prescribes a content and a routing destination for the text message based on the substantive data and the routing data.

11. The apparatus of claim 1, wherein the router is a real time transaction server and the message generator comprises a message web server and a manual message generator.

12. The apparatus of claim 11, wherein the real time transaction server transmits the input to the message web server.

13. The apparatus of claim 11, wherein the message generator transmits the input to the message web server.

14. The apparatus of claim 13, wherein the message web server utilizes the input to locate substantive data and routing data in the database, and the message web server transmits the substantive data and the routing data to the manual message generator.

15. The apparatus of claim 14, wherein the manual message generator is configured to enable a user to view the substantive data and the routing data.

16. The apparatus of claim 15, wherein the manual message generator is configured to enable the user to manually prescribe a content and a destination for the text message based on the substantive data and the routing data.

17. A method for communicating, comprising:
receiving an input;
retrieving data from a database based on the input;
analyzing the data and the input;
generating a text message based on an analysis of the data and the input, and
routing the text message to a peripheral.

18. The method of claim 17, wherein the data is retrieved from a database by a automatic message generator based on the input.

19. The method of claim 18, wherein the message generator automatically prescribes a content and a routing destination for the text message based on an analysis of the data and the input.

20. The method of claim 17, wherein the data is retrieved from a database by a message web server based on the input from a manual message generator, and the message web server transmits the data to the manual message generator.

21. The method of claim 20, wherein the manual message generator presents the data to an operator.

22. The method of claim 21, wherein the manual message generator is configured to enable the operator to select among the presented data to manually prescribe a content and routing destination for the text message.

23. An apparatus for automatically constructing and routing a message, comprising:
a computer processing device linked to a network and configured to receive data from the network, analyze the data and provide a text message to the network;
a router linked to the computer processing device configured to route an input and the text message;
a database linked to the router configured to receive, store and provide substantive data and routing data; and
a real time transaction server linked to the database and configured to transmit the input to an automatic message generator,
wherein, upon receiving the input, the automatic message generator is configured to utilize the input to locate the substantive data and the routing data, prescribe a content for the text message based on the substantive data, and prescribe a routing destination for the text message based on the routing data.
